(19) United States
(12) Patent Application Publication
(10) Pub. No.: US 2014/0237897 A1
(43) Pub. Date: Aug. 28, 2014

(54) Means And Methods for Growing Plants in High Salinity Or Brackish Water

(71) Applicant: SEANOVO LTD., London (GB)

(72) Inventors: Izhak Levi Lotvak, Midreshet Ben-Gurion (Sde Boker) (IL); Gil Shani, Giv'at Shapira (IL); Eyal Ronen, Tel Aviv (IL)

(21) Appl. No.: 14/349,376

(22) PCT Filed: Oct. 3, 2012
(86) PCT No.: PCT/IB2012/055301

§ 371 Date: Apr. 3, 2014

(30) Foreign Application Priority Data
Oct. 3, 2011 (IL) 215501

(51) Int. Cl. A01G 31/02

(52) U.S. Cl. CPC A01G 31/02
USPC 47/62 R

(57) ABSTRACT

A method of growing plants in high salinity is hereby presented. The method comprises steps of obtaining a pressurised cultivation system (PCS) having a pressure vessel for growing at least one plant on a media or substrate, the pressure vessel housing at least the roots of said at least one plant, a source of saline water and a high pneumatic pressure production unit operatively connected to said pressure vessel for providing higher than ambient pressure to said pressure vessel, thereby maintaining said roots of said at least one plant under high pressure during growth, planting a plant in the pressure vessel such that at least a portion of said roots are hermetically sealed within said pressure vessel, providing saline or brackish water to said media and pressurising said vessel. Systems and devices for the above are described.

### CROSS-REFERENCE TO RELATED APPLICATIONS

The present patent application claims priority from IL Patent Application 215501, filed Mar. 10, 2011, entitled, “Irrigating Plants with Salty Water” which is incorporated herein by reference.

### FIELD OF THE APPLICATION

The present invention relates generally to plant growing systems, apparatus and methods, and specifically to systems, apparatus and methods of enabling plants to grow under conditions of high salinity.

### BACKGROUND OF THE INVENTION

The present invention describes means and methods for growing plants in high salinity or brackish water.

Crop growth is inhibited by high salt, and various techniques have been employed to extend the maximum salinity range in which plants may be grown.

GB808645A discloses a process for treating water used for irrigation purposes relates to electromagnetic means for reducing salt in irrigation supply networks.

U.S. Pat. No. 4,687,505A provides a method for the desalination and reclamation of irrigated soils through application to the soil of minute amounts of one or more anionic compounds having threshold properties in dilute aqueous solution.

In DE3344945A the invention relates to a method and device for soilless raising and cultivation of plants, preferably in the open, on slanting: planes which are created by securing and sealing the ground surface, and in which the roots of the plants are supplied nutrients dissolved in a running water flow.

EP1334781 A discloses a method of treating sediment spread over large areas selection of a plant species (12) which is resistant to salinity and able to vaporise considerable amounts of water and absorb the pollutants present in the soil, (c) sowing and cultivation in the area of a plant species (12) so that its roots form a close-knit web in the soil,

US2010186298A reports methods for cultivating, plants includes placing a plant body to be cultivated on a film laid on or in water-containing, soil and substantially getting integral with the roots of the plant body appropriately together with a plant cultivation supporting body, supplying water and fertilizer to the ground soil under the film, and appropriately supplying water and/or fertilizer also above the film after the roots of the plant body and the film are substantially integrated.

EP2116130A discloses a hydroponic watering system for pluriannual tree and hush plantations, wherein the water bulb where the roots of the tree are fed, is situated on the ground or partially buried, in a container that is waterproof and dark in colour to prevent sunlight from affecting the normal development of the roots.

CN102057854A discloses a big seedling transplanting method for inshore saline-alkali land. Irrigation with large amounts of water to remove salt and reduce alkali, is done to provide favourable conditions for reducing salt.

There remains a long felt and unmet need to provide means and methods for growing plants in high saline or brackish water.

### SUMMARY OF THE INVENTION

It is an object of the present invention to disclose a method of growing plants in high salinity, said method comprising steps of obtaining a pressurised cultivation system (PCS) having a pressure vessel for growing at least one plant on a media, said pressure vessel housing at least the roots of said at least one plant, a source of saline water and a high pneumatic pressure production unit operatively connected to said pressure vessel for providing higher than ambient pressure to said pressure vessel, thereby maintaining said roots of said at least one plant under high pressure during growth; planting a plant in the pressure vessel such that at least a portion of said roots are hermetically sealed within said pressure vessel; providing saline or brackish water to said media and pressurising said vessel

It is an object of the present invention to disclose the aforementioned method wherein said method further comprises steps of providing said pressure vessel with an opening such that said opening is hermetically sealable around a part of said at least one plant such that the lower portion of said at least one plant is in said pressure vessel whilst the upper portion of said at least one plant is in the ambient environment.

It is an object of the present invention to disclose the aforementioned method wherein said system is provided with at least one pressure release valve.

It is an object of the present invention to disclose the aforementioned method wherein said system is provided with at least one pressure release valve.

It is an object of the present invention to disclose the aforementioned method wherein said system is provided with at least one pressure sensor.

It is an object of the present invention to disclose the aforementioned method wherein said system is provided with at least one sensor selected from the group consisting of water salinity sensor, humidity sensor, light intensity sensor, temperature sensor, oxygen sensor, leaf transpiration sensor or any other pertinent sensor for the plant or the media or substrate or atmosphere or environment in which the root or rhizosphere is grown.

It is an object of the present invention to disclose the aforementioned method wherein said system is provided with at least one water flow valve at the inflow to said pressure vessel.

It is an object of the present invention to disclose the aforementioned method wherein said system is provided with at least one water flow valve at the outflow of said pressure vessel.

It is an object of the present invention to disclose the aforementioned method wherein said system is adapted for growing several plants from a single pressure vessel.

It is an object of the present invention to disclose the aforementioned method wherein said system is provided with a battery of pressure vessels.

It is an object of the present invention to disclose the aforementioned method wherein said system is adapted for growing plants by any method from the group consisting of soiless culture, aeroponics, aquaponics, aquascaping, Hydroponics, Passive hydroponics or any combination thereof.

It is an object of the present invention to disclose the aforementioned method wherein said system is adapted for growing plants by any method selected from the group consisting of soiless culture, methods of growing detached from the soil, Aquatic gardening, •Bottle gardening, bubbleponics, Deep water culture, Ebb and flow methods, fogponics microponics, Nutrient film techniques, Organic hydroponics, •Sub-irrigated planter methods or any combination thereof.

It is an object of the present invention to disclose the aforementioned method wherein said pressure vessel is provided with at least one media or substrate selected from the group consisting of soil, growstones, charcoal, Coco peat, peat moss, Coco fibers, Diatomaceous earth, Gravel, Perlite, Pumice, Rockwool, Sand •Vermiculite, Parboiled rice hulls, dolomites, basalt, expanded clay, aggregate, chalk, limestone, artificial polymer substrates, organic matter, mineral medium, organic medium and inert medium and any combination between them or any proportion thereof.

It is an object of the present invention to disclose the aforementioned method wherein said system is provided with at least one accessory selected from the group consisting of Drip irrigation components growlight, hydroponic dosers, Irrigation sprinklers, Leaf sensors, Net-pots, Spray nozzles, Timers, Ultrasonic foggers, Water chillers.

It is an object of the present invention to disclose the aforementioned method wherein said pressure vessel comprises an inflatable balloon open at one hermetically sealable end for enclosing said roots. In some embodiments all the root system may be enclosed, or single root branches, or parts of root branches.

It is an object of the present invention to disclose the aforementioned method wherein said pressure vessel comprises an inflatable sleeve open at at least two hermetically sealable ends for enclosing around said roots such that at least a portion of said roots protrudes from beyond at least one said sleeve opening. As in the aforementioned embodiments, all the root system may be enclosed, or single root branches, or parts of root branches.

It is an object of the present invention to disclose the aforementioned method wherein said pressure vessel is adapted to be fitted to positively or negatively gravitropic aerial roots.

It is an object of the present invention to disclose the aforementioned method wherein said pressure vessel is adapted to be retrofitted to a crop, plant, shrub, bush, sapling or tree which is growing in a field.

It is an object of the present invention to disclose the aforementioned method wherein said pressure vessel is adapted to be fitted to a root of a scion or rootstock of a grafted plant.

It is an object of the present invention to disclose the aforementioned method wherein said PCS is adapted to enable salt water to recirculated and fresh nutrients may be added as required or according to a specific protocol.

It is an object of the present invention to disclose the aforementioned method wherein said salt water is provided under high pressure.

It is an object of the present invention to disclose the aforementioned method wherein several pressure vessels are networked in an integrated system controlled by a central controller.

It is an object of the present invention to disclose the aforementioned method wherein more than one fields or greenhouses or growing establishments are networked in an integrated system controlled by a central controller.

It is an object of the present invention to disclose the aforementioned method wherein the system is further comprises a central controller and a central server adapted to receive plant physiology, plant growth, plant health or other relevant agrotechnical or agricultural data from at least some plants fitted with said pressure vessels.

It is an object of the present invention to disclose the aforementioned method wherein said system is further provided with a processor for processing said plant physiology, plant growth, plant health or other relevant agrotechnical or agricultural data.

It is an object of the present invention to disclose the aforementioned method wherein said system is provided with a computer readable medium for providing instructions to the controller to adjust the pressure in the aforementioned pressure vessels in a predetermined manner.

It is an object of the present invention to disclose a pressurised cultivation system (PCS) for growing plants in high salinity having a pressure vessel for growing at least one plant on a media or substrate, said pressure vessel housing at least the roots of said at least one plant, a source of saline water and a high pneumatic pressure production unit operatively connected to said pressure vessel for providing higher than ambient pressure to said pressure vessel, thereby maintaining said roots of said at least one plant under high pressure during growth.

It is an object of the present invention to further disclose the aforementioned system wherein said pressure vessel is provided with an opening such that said opening is hermetically sealable around a part of said at least one plant such that the lower portion of said at least one plant is in said pressure vessel whilst the upper portion of said at least one plant is in the ambient environment.

It is an object of the present invention to disclose the aforementioned system wherein said system is provided with at least one pressure release valve.

It is an object of the present invention to disclose the aforementioned system wherein said system is provided with at least one pressure sensor.

It is an object of the present invention to disclose the aforementioned system wherein said system is provided with at least one water salinity sensor.

It is an object of the present invention to disclose the aforementioned system wherein said system is provided with at least one water flow valve at the inflow to said pressure vessel.

It is an object of the present invention to disclose the aforementioned system wherein said system is provided with at least one water flow valve at the outflow of said pressure vessel.

It is an object of the present invention to disclose the aforementioned system wherein said system is adapted for growing several plants from a single pressure vessel.

It is an object of the present invention to disclose the aforementioned system wherein said system is provided with a battery of pressure vessels.

It is an object of the present invention to disclose the aforementioned system wherein said system is adapted for growing plants by any method from the group consisting of soiless growth, aeroponics, aquaponics, aquascaping, hydroponics, passive hydroponics or any combination thereof.

It is an object of the present invention to disclose the aforementioned system wherein said system is adapted for growing plants by any method selected from the group consisting of soiless culture, Aquatic gardening, •Bottle gardening, bubbleponics, Deep water culture, Ebb and flow methods, fogponics microponics, Nutrient film techniques, Organic hydroponics, •Sub-irrigated planter methods or any combination thereof.

It is an object of the present invention to disclose the aforementioned system wherein said pressure vessel is provided with at least one media or substrate selected from the group consisting of soil, growstones, charcoal, Coco peat, peat moss, Coco fibers Diatomaceous earth, Gravel, Perlite, Pumice, Rockwool, Sand •Vermiculite, Parboiled rice hulls, dolomites, basalt, expanded clay, aggregate, chalk, limestone, artificial polymer substrates, organic matter, mineral medium, organic medium and inert medium and any combination between them or any proportion thereof.

It is an object of the present invention to disclose the aforementioned system wherein said system is provided with at least one accessory selected from the group consisting of Drip irrigation components growlight, hydroponic dosers, irrigation sprinklers, leaf sensors, net-pots, spray nozzles, timers, ultrasonic foggers, water chillers.

It is an object of the present invention to disclose the aforementioned system wherein said pressure vessel comprises an inflatable balloon open at one hermetically sealable end for enclosing said roots.

It is an object of the present invention to disclose the aforementioned system wherein said pressure vessel comprises an inflatable sleeve open at at least two hermetically sealable ends for enclosing around said roots such that at least a portion of said roots protrudes from beyond at least one said sleeve opening.

It is an object of the present invention to disclose the aforementioned system wherein said pressure vessel is adapted to be fitted to positively or negatively gravitropic aerial roots.

It is an object of the present invention to disclose the aforementioned system wherein said pressure vessel is adapted to be retrofitted to a crop, plant, shrub, bush, sapling or tree which is growing in a field.

It is an object of the present invention to disclose the aforementioned system wherein said pressure vessel is adapted to be fitted to a root of a scion or rootstock of a grafted plant.

In some embodiments all the root system may be enclosed, or single root branches, or parts of root branches.

It is an object of the present invention to disclose the aforementioned system wherein said PCS is adapted to enable salt water to recirculated and fresh nutrients added as required or according to a specific protocol.

It is an object of the present invention to disclose the aforementioned system wherein said salt water is provided under high pressure.

It is an object of the present invention to disclose the aforementioned system wherein several pressure vessels are networked in an integrated system controlled by a central controller.

It is an object of the present invention to disclose the aforementioned system wherein more than one fields or greenhouses or growing establishments are networked in an integrated system controlled by a central controller.

It is an object of the present invention to disclose the aforementioned system further comprising a central controller and a central server adapted to receive plant physiology, plant growth, plant health or other relevant agrotechnical or agricultural data from at least some plants fitted with said pressure vessels.

It is an object of the present invention to disclose the aforementioned system wherein said system is further provided with a processor for processing said plant physiology, plant growth, plant health or other relevant agrotechnical or agricultural data.

It is an object of the present invention to disclose the aforementioned system wherein said system is provided with a computer readable medium for providing instructions to the controller to adjust the pressure in the aforementioned pressure vessels in a predetermined manner.

It is an object of the present invention to provide the aforementioned method adapted to off-shore applications such as growing crops on a vessel, rig, raft, boat or other marine installation that moves on the ocean while pumping seawater.

The vessel, rig, raft, boat or other marine installation may move from one country to another or remain stationary and collect the abundant seawater.

The vessel, rig, raft, boat or other marine installation may cruise between one convenient location and head to the country market while growing the crops with the aforementioned method or system and harvest freshly upon arrival at the appropriate country market.

The above mentioned marine installation may be a moored, fixed floating vessel.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which aspects of a pressurised cultivation system (PCS) for growing plants in high salinity are illustrated|:

FIG. 1 is a schematic illustration of an aspect of the present invention;

FIG. 2 is a schematic illustration of an aspect of the present invention;

FIG. 3 is a schematic illustration of an aspect of the present invention; and

FIG. 4 is a schematic illustration of an aspect of the present invention.

### DETAILED DESCRIPTION OF THE INVENTION

The following description is provided, alongside all chapters of the present invention, so as to enable any person skilled in the art to make use of the aforesaid invention, and sets forth the best modes contemplated by the inventor of carrying out this invention. Various modifications, however, are adapted to remain apparent to those skilled in the art, since the generic principles of the present invention have been defined specifically to provide means and methods for growing plants, by holding the plant roots under a high pressure environment so as to enable growth of plants in higher than normal salt conditions.

In general the present invention is directed to high value greenhouse crops such as Tomato Pepper Cucumber and horticultural flowers.

Embodiments of the invention are also suitable for orchards (such as apples, citrus, avocado, mango, and almond), fruit trees and viticulture, nut trees, tobacco and cotton.

In other embodiments of the present invention adaptations are made to support the growth of open-field crops among them field vegetables, orchards of all kinds and broad-acre crops like: wheat, maize, cotton, soy, tobacco and the like.

Definitions

It is herein stated that conventional state of the art knowledge and assumptions are drawn, without being bound by theory, from the book Plants in Action, Australian Society of Plant Scientists, New Zealand Society of Plant Biologists, and New Zealand Institute of Agricultural and Horticultural Science 1999, which is incorporated herein in it's entirety.

It is herein acknowledged that plants may also include, for he purposes of the present disclosure of the invention, plant parts, calluses, cells, tissue cultures, meristems, grafts, seeds, germinated seeds, seedlings and the like.

It is herein acknowledged that the term media is interchangeable with the term substrate.

Osmotic pressure is the pressure which needs to be applied to a solution to prevent the inward flow of water across a semipermeable membrane. It is also defined as the minimum pressure needed to nullify osmosis.

The phenomenon of osmotic pressure arises from the tendency of a pure solvent to move through a semi-permeable membrane and into a solution containing a solute to which the membrane is impermeable. This process is of vital importance in biology as the cell's membrane is selective toward many of the solutes found in living organisms.

Osmotic potential is defined as the potential of water molecules to move from a hypotonic solution (more water, less solutes) to a hypertonic solution (less water, more solutes) across a semi permeable membrane.

Water potential is the defined as the degree to which a solvent tends to stay in a liquid.

Osmotic pressure is an important factor affecting cells. Osmoregulation is the homeostasis mechanism of an organism to reach balance in osmotic pressure.
Hypertonicity is the presence of a solution that causes cells to shrink.
Hypotonicity is the presence of a solution that causes cells to swell.
Isotonic is the presence of a solution that produces no change in cell volume.

When a biological cell is in a hypotonic environment, the cell interior accumulates water, water flows across the cell membrane into the cell, causing it to expand. In plant cells, the cell wall restricts the expansion, resulting in pressure on the cell wall from within called turgor pressure.

Osmotic pressure is the basis of filtering (“reverse osmosis”), a process commonly used to purify water. The water to be purified is placed in a chamber and put under an amount of pressure greater than the osmotic pressure exerted by the water and the solutes dissolved in it. Part of the chamber opens to a differentially permeable membrane that lets water molecules through, but not the solute particles. The osmotic pressure of ocean water is about 27 ATM. Reverse osmosis desalinates fresh water from ocean salt water.

Osmotic pressure is necessary for many plant functions. It is the resulting turgor pressure on the cell wall that allows herbaceous plants to stand upright, and how plants regulate the aperture of their stomata.

Potential osmotic pressure is the maximum osmotic pressure that could develop in a solution if it were separated from distilled water by a selectively permeable membrane. It is the number of solute particles in a unit volume of the solution that directly determines its potential osmotic pressure. If one waits for equilibrium, osmotic pressure reaches potential osmotic pressure.

Salinity and Crop Growth.

It is well known that soil salt and water salt restricts plant growth so that crop yield is reduced, but species differ in sensitivity. Four broad categories of salt tolerance were delineated by the USDA Soil Salinity Laboratory, Riverside, from a statistical analysis of an extensive survey of published data on yield and soil salinity (measured as electrical conductivity (ECE) of a saturated extract and expressed here as deciSiemens per metre (dS m-1)). Crops representative of each category are listed in Table 1. (Based on Maas and Hoffman 1977 as quoted in the above referenced Plants in Action).

Salts dissolved in soil water inhibit plant growth because (1) salt reduces water uptake, and (2) excessive salt becomes toxic and causes further reductions in growth. To exist in a saline soil, plants must take up water but exclude salt.

Extensive research in California during the 1970s (USDA Salinity Laboratory, Riverside) provided baseline data on comparative salt tolerance for a wide range of crop plants. Statistical analysis of this far-ranging survey of crop plants showed that (1) yield did not generally decrease significantly until a salinity threshold had been exceeded, and (2) that yield generally decreased linearly with further increase in salinity. Some deviations from linearity occurred as relative crop yield dropped below 20-30%. The yield-salinity relationship becomes steeper, and threshold salinity decreases from ‘tolerant’ to ‘sensitive’ categories. Representative crops in each category highlight a number of horticultural species as sensitive or moderately sensitive, compared with cereals and coarse grains that are either moderately tolerant or tolerant.

For survey purposes, soil was regarded as saline if electrical conductivity of a saturated extract was more than 4-5 dS m-1, equivalent to about 40-50 mM NaCl, and sensitive plants such as lupin are greatly reduced at this level of salinity. By contrast, tolerant plants such as barley withstand 8 dS m-1 (equivalent to about 80 mM NaCl) while specialised halophytes grow under highly saline conditions, with NaCl concentrations reaching or even exceeding that of sea water, which is about 500 mM.

Table 1 shows the relative salt tolerance of selected crop plants from a broad survey by the USDA Salinity Laboratory, Riverside, corresponding to FIG. 17.2 of the above referenced Plants in Action.

| | Moderately | Moderately | |
|---|---|---|---|
| Sensitive | Sensitive | Tolerant | Tolerant |
| Almond | Broadbean | Beet | Barley |
| Apple | Cabbage | Broccolli | Bermuda Grass |
| Apricot | Capsicum | Bromegrass | Cotton |
| Avocado | Clover | Tall Fescue | Date |
| Bean | Cucumber | Olive | Sugarbeet |
| Carrot | Grape | Ryegrass, Perennial | |
| Citrus | Lettuce | Safflower | |
| Onion | Lucerne | Sorghum | |
| Peach | Maize | Wheat | |
| Plum | Peanut | | |
| Strawberry | Potato | | |
| | Spinach | | |
| | Sugarcane | | |
| | Tomato | | |

Table 1 above and Table 2 (Species of major crops, their families, use and region of origin From: Simmonds, N. W. 1976. Evolution of Crop Plants. Longman, London & New York) below provides a non-limiting list of plants, crops and families which, the generic principles of the present invention having been described herein, are all envisaged to be subject to the novel and inventive method described herein for growing plants, by holding the plant roots under a high pressure environment so as to enable growth of plants in higher than normal salt conditions. Other plants are also contemplated to be amenable to be grown with the herein described means and methods.

| | | | |
|---|---|---|---|
| AGAVACEAE | Agave | Sisal and relatives | Central |
| | | Fibre | America & |
| | | | Mexico |
| AMARANTHACEAE | Amaranthus spp | Grain amaranths | The Americas |
| | | Grain | |
| ANACARDIACEAE | Mangifera indica | Mango | India |
| | | Fruit (tree) | |
| ARACEAE | Alocasia, Colocasia, | Edible aroids: taro, | Asia; S. |
| | Cyrtosperma, Xanthosoma | eddo, dasheen, | America |
| | | tanier, yautia, | |
| | | cocoyam | |
| | | Corms & leaves | |
| BOMBACACEAE | Ceiba pentandra | Kapok | American &/or |
| | | Fibre from fruit | Africa |
| | | (tree) | |
| BROMELIACEAE | Ananas comosus | Pineapple | S. America |
| | | Fruit | |
| CAMELLIACEAE | Camelia sinensis | Tea | SE Asia |
| CARICACEAE | Carica papya | Papaya | Tropical |
| | | Fruit | America |
| CHENOPODIACEAE | Beta vulgaris | Sugar beet | Europe |
| | | Sugar (from root) | |
| | Chenopodium spp | Quinoa and relative | C.& S. |
| | | Grain | America |
| COMPOSITAE | Carthamus tinctorius | Safflower | Near East |
| | | Oilseed | |
| | Chrysanthemum spp | Pyrethrum | Asia & Europe |
| | | Insecticide | |
| | Helianthus annus | Sunflower | USA |
| | Helianthus tuberosus | Oil Jerusalem | |
| | | artichoke | |
| | | Tubers | |
| | Lactuca sativa | Lettuce | Old World |
| | | Leaves | |
| CONVOLVULACEAE | Ipomea batatas | Sweet potato | Mexico, C. or |
| | | Tubers | S. America |
| CRUCIFEREAE | Brassica campestris | Turnip & relatives | Mediterranian |
| | | Storage organs, | & Afghanistan, |
| | | leaves, seeds (for oil) | Pakistan |
| | Brassica oleracea | Cabbages, kales etc. | Mediterranian |
| | | Leaves, buds, stems, | &/or Asia |
| | | influorescence | Minor |
| | Brassica napus | Swedes and rapes | Europe or |
| | | Forage; oilseed | Mediterranian |
| | Brassica spp and | Mustards | Mediterranean |
| | Sinapis alba | Spice, oil seed, | |
| | | leaves | |
| | Raphanus sativus | Radish | Some area east |
| | | Roots; leaves, seeds | of |
| | | | Mediterranian |
| | Rrippa nasturtium- | Watercress | Europe |
| | aquaticum | Leaves | |
| CUCURBITACEAE | Cucumis, sativus Cucumis | Cucurbits: | India Africa, |
| | mela Citrullus, lanatus | Cucumber | India S. Africa |
| | Cucrbita spp Lagenaria | Musk melon | Americas |
| | niceraria | watremellon | Africa |
| | | squashes, pumpkins | |
| | | wh-flowered gourd | |
| DIOSCOREACEAE | Dioscorea spp | Yams | Asia Africa, |
| | | roots | tropical |
| | | | America |
| EUPHORBIACEAE | Aleurites spp | Tung | China |
| | | Oil for paints, | |
| | | varnishes | |
| | Hevea brasiliensis | Rubber | S. America |
| | Manihot esculenta | Cassava | Tropical |
| | | Roots | America |
| | Ricinus communis | Castor | Africa |
| | | Oil for industry; | |
| | | medicinal | |
| GRAMINEAE | Avena spp | Oats | Near East |
| | | Grain, straw | |
| | Eleusine coracana | Finger millet Bulrush | Africa |
| | Pennisetum americanum | millet | |
| | | grain | |
| | Hordeum vulgare | Barley | Near East |
| | | grain | |
| | Oryza sativa O. glaberrima | Asian Rice African | Asia Africa |
| | | Rice | |
| | | grain | |
| | Saccharum spp | Sugarcanes | New Guinea |
| | | Stems for sugar | |
| | Secal cereale | Rye | Near East |
| | | Grain, straw, forage | |
| | Sorghum bicolor | Sorghum | Africa |
| | | Sudan grasses | |
| | | Grain, straw, forages | |
| | Tritisecale spp | Triticale | Modern |
| | | Grain | intergeneric |
| | | | hybrid of wheat |
| | | | and rye |
| | Triticum spp | Wheat | Near East |
| | | grain | |
| | Zea mays | Maize, corn | Americas |
| | | Grain, forage | |
| | Lolium, festuca, Dactylis, | Tmeperate herbage | Europe |
| | Phleum, Bromus | grasses | |
| | Panicum, Pennisetum, | Tropical grasses | Africa |
| | Cynodon | Herbage | |
| GROSSULARIACEAE | Ribes spp | Curants | Europe |
| LAURACEAE | Persea americana | Avocado Fruit | C. America |
| LEGUMINOSEAE | Arachis hypogaea | Groundnut (peanut) | S. America |
| | Cajanus cajan | Pigeon pea Grain | India? |
| | Cicere arietunum | Chickpea Grain | W. Asia |
| | Glycine max | Soybean Grain; oil | China |
| | Lens culinaris | Lentil Grain | Near East |
| | Medicago sativa | Alfalfa Forage | Near East |
| | Phaseoulus spp | Beans | Middle & S. |
| | | | America |
| | Pisum sativum | Peas Grain | Ethiopia or |
| | | | Mediterranian |
| | | | or C. Asia |
| | Trifolium spp | Clovers Forages | Eastern |
| | | | Mediterranian |
| | Vicia faba | Field bean Grain | Near east |
| | Vigna unguiculata | Cowpeas Grain, | Africa |
| | | Vegetable, fodder | |
| LILIACEAE | Allium | Onion and allies | Central |
| | | Vegetables | Asia/Near East |
| LINACEAE | Linum usitatissimum | Flax and Linseed Oil | ?India |
| | | and fibre | |
| MALVACEAE | Abelmoschus esculentus | Okra Fruits (as | Africa |
| | | vegetable) | |
| | Gossypium spp | Cotton Hairs on | Tropical |
| | | seeds | America, |
| | | | Asiua, Africa |
| MORACEAE | Artocarpus spp | Breadfruit and | Malaysia |
| | | relatives Fruit | |
| | Cannabis sativa | Hemp Fibre; oilseed | Temperate Asia |
| | Ficus carica | Fig | Southern |
| | | | Arabia |
| | Humulus lupulus | Hops Brewing | Europe |
| MUSACEAE | Musa spp | Bananas | Malaysia |
| MYRTACEAE | Eugenia caryophyllus | Clove Oil, spice | Indonesia |
| OLEACEAE | Olea europaea | Olive Oil | Near East |
| PALMAE | Cocos nucifera | Cocount | Southeast Asia |
| | Elaeis guineeensis | Oil palm Oil | Africa |
| | Phoenix dactylifera | Date palm fruit | N. Africa |
| PEDALIACEAE | Sesamum indicum | Sesame Oilseed | ?Ethiopia or |
| | | | India |
| PIPERACEAE | Piper nigrum | Black pepper | India |
| POLYGONACEAE | Fagopyrum | Buckwheat Grain | Temperate |
| | | | eastern Asia |
| ROSACEAE | Fragaria ananassa | Strawberry Fruit | Europe, N & S. |
| | | | America |
| | Prunus spp | Cherry, plum, peach, | C. Asia, China, |
| | | Apricot, almond | N. America |
| | | Fruit | |
| | Malus & Pyrus spp | Apple and Pear | Asia Minor, C. |
| | | | Asia |
| | Rubus spp | Raspberries and | Europe, N. |
| | | blackberries | America |
| RUBIACEAE | Cinchona spp | Quinine Drug | Andes |
| | Coffea spp | Coffee Seeds | Ethiopia |
| RURACEAE | Citrus spp | Citrus fruits | India |
| SOLANACEAE | Capsicum spp | Peppers | C. & S. |
| | | | America |
| | Lycoperscion esculentum | Tomato | S. America |
| | Nicotinia tabacum | Tobacco Leaves | Americas |
| | Solanum tuberosum | Potatoes Tubers | Bolivia-Peru |
| STERCULIACEAE | Cola spp | Kola nuts (tree) | Africa |
| | | Seeds | |
| | Theobroma cacao | Cacao Seeds from | S. America |
| | | fruit | |
| TILIACEAE | Corchorus spp | Jute Fibre | India |
| UMBELLIFERAE | Daucus carota | Carrot Root | Europe |
| VITACEAE | Vitis Muscadinia | Grapes | Middle Asia |

In some embodiments of he present invention the whole root system is inserted into and maintained under pressurized conditions, and in other embodiments only part of the root system is inserted into and maintained under into pressurized conditions. In some embodiments all the root system may be enclosed, or single root branches, or parts of root branches.

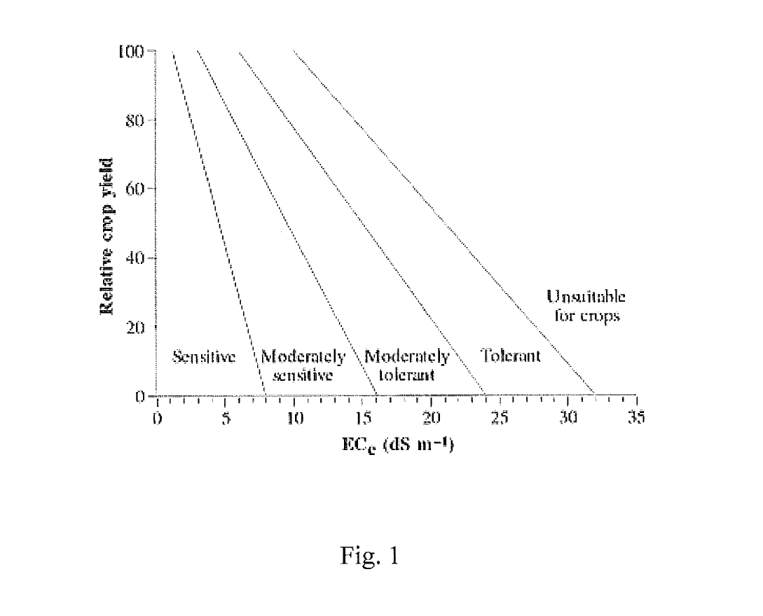

FIG. 1 is now referred to: Soil salt restricts plant growth so that crop yield is reduced, but species differ in sensitivity. These four broad categories of salt tolerance were delineated by the USDA Soil Salinity Laboratory, Riverside, from a statistical analysis of an extensive survey of published data on yield and soil salinity (measured as electrical conductivity (ECE) of a saturated extract and expressed here as deciSiemens per meter (dS m⁻¹)). Crops representative of each category are listed in Table 17.3. (Based on Maas and Hoffman 1977)

Salts dissolved in soil water inhibit plant growth because (1) salt reduces water uptake, and (2) excessive salt becomes toxic and causes further reductions in growth. To exist in a saline soil, plants must take up water but exclude salt. The present invention provides a system for enclosing the roots or rhizosphere of the plant under high pneumatic pressure, so as to enable the plant to grow under higher than normal saline conditions. The present invention provides means and methods for increasing the salt exclusion properties of the roots in a given species.

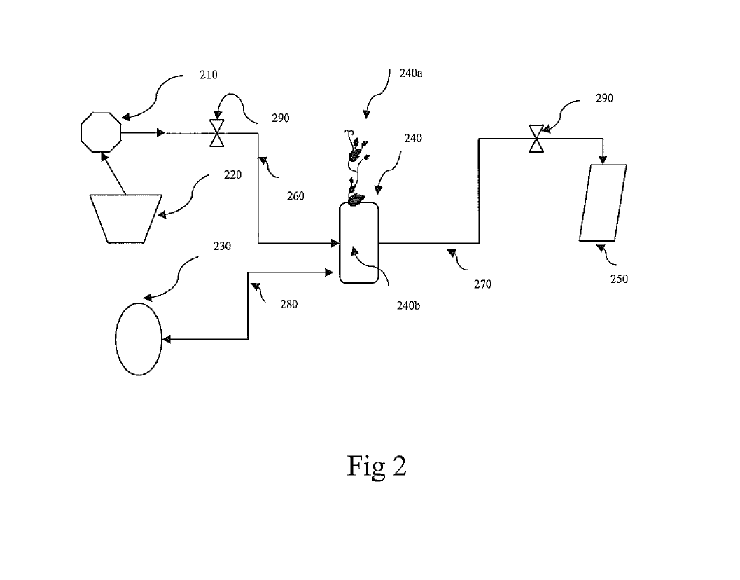

Reference is now made to FIG. 2 which is a schematic representation of an exemplary embodiment, of the present invention, namely a pressurised cultivation system (PCS) for growing plants in high salinity. The aforementioned system comprises a pressurised container or vessel 240 partially filled with liquid for hydroponic growth and air, with an airtight sealable upper portion in which the plant is rooted, and a portion of the growing plant 240a is exposed to the air. A source of salt water and nutrients 220 is provided which is pumped into the container by a pump unit 210. A high pressure production (compressor) and regulator unit 230 provides a high pressure environment 240b in the pressurised container or vessel. Salty water is injected into the system by the pump, creating pressure which is higher than the maintained pressure provided by the compressor 230, thereby creating a pressurized environment. In such a case the pressurised environment is the result of the high pressure injection of salt water and the work done by the compressor. In some embodiments of the present invention, the salty water may be at a higher altitude than the pressurised vessels and thus the salty water supply contributes to the pressurisation by way pressure difference between a high location and a low location. Such an arrangement will be energy saving. A high pressure production and regulator unit 230 provides a high pressure environment 240b in the pressurised container or vessel. In some embodiments of the system a valve 290 regulates the outflow of spent salt water through the system. The spent salt water may be collected in a container 250 for further use, disposal or processing. Water pipes 260,270,280 connect the components of the system.

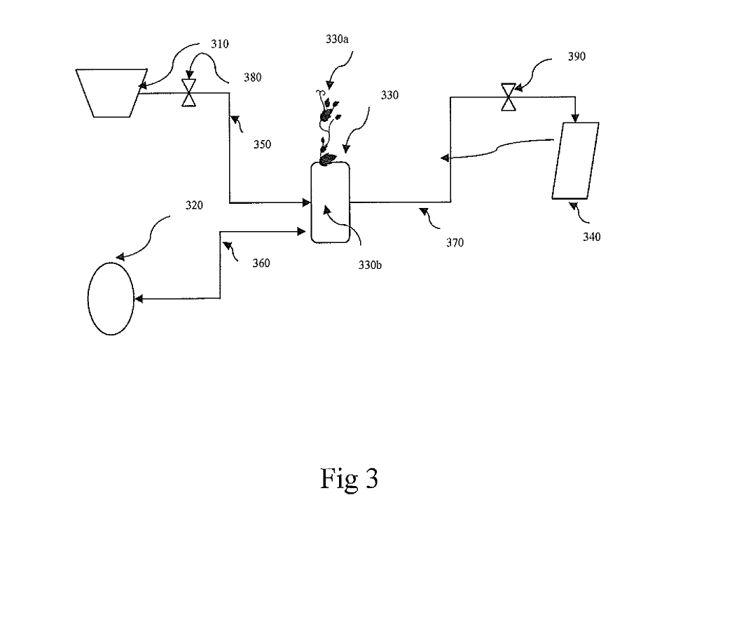

Reference is now made to FIG. 3 which is a schematic representation of an exemplary embodiment, of the present invention, namely a pressurised cultivation system (PCS) for growing plants in high salinity. The aforementioned system comprises a pressurised container or vessel 330 partially filled with liquid for hydroponic growth and air, with an airtight sealable upper portion in which the plant is rooted, and a portion of the growing plant 330a is exposed to the air. A source of salt water and nutrients 310 is provided. In some embodiments of the present invention valves 380 are provided for regulating flow from the aforementioned source. A high pressure production and regulator unit 320 provides a high pressure environment 330b in the pressurised container or vessel. In some embodiments of the system a valve 390 regulates the outflow of spent salt water through the system.

The spent salt water may be collected in a container 340 for further use, disposal or processing.

Water pipes 350,360, 370 connect the components of the system.

It is herein acknowledged that in some embodiments of the invention, the pressure vessels are inflatable balloon like structures sealable around the plant root at at least one, or in other cases, two openings.

In some embodiments of the present invention, where it is topographically suitable, high pressure injection of salt water is not needed, but rather the pressure difference due to altitude is used.

In some embodiments of the invention the pressurised vessel provides a definition sealed environment which may be a sealed plastic box, balloon or any other structure made of a material that can withstand the pressurized conditions and support a sealed environment.

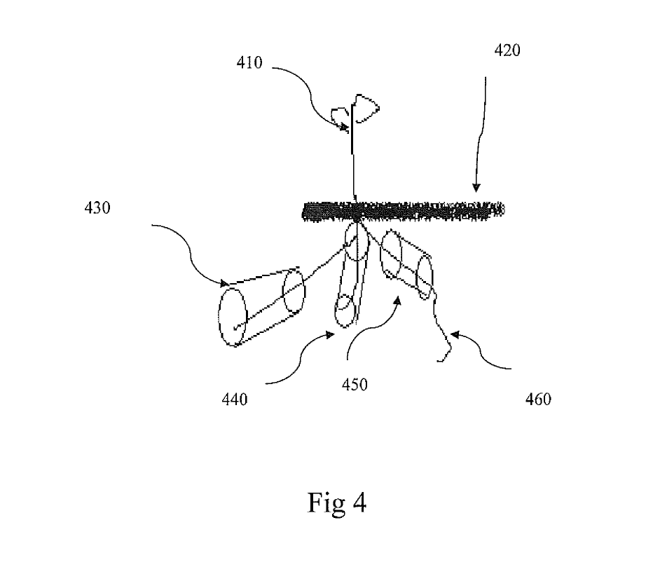

Reference is now made to FIG. 4, which schematically illustrates aspects of some embodiments of the present invention.

The plant 410 is rooted in a media or substrate 420. The root system 460 may wholly or partially be enclosed in a pressure vessel of the invention. In a non limiting example, a pressurised vessel 430 encloses the lower end of one branch of the root system or rhizosphere, another vessel 440 encloses another branch, and another pressurised vessel 450 encloses part of the root branch. Note that pressurised vessel 450 is sleeve-like and has two sealable openings.

In some embodiments of the present invention the whole root system is inserted into and maintained under pressurized conditions, and in other embodiments only part of the root system is inserted into the pressure vessel and maintained under pressurized conditions.

In some embodiments of the present invention the system is so arranged as to utilize the atmospheric pressure differences between high mountain and low valley in topographically suitable areas.

In some embodiments of the invention the system excess water is collected by drainage and is utilised for other uses or returned back to its source (for example in the case of seawater).

In some embodiments of the invention the salt water is recirculated and fresh nutrients are added.

In some embodiments of the system the salt water is provided under high pressure.

In some embodiments of the present invention several pressure vessels are networked in an integrated system controlled by a central controller.

In some embodiments of the present invention several fields or greenhouses or growing establishments are networked in an integrated system controlled by a central controller.

In some embodiments of the invention a central controller is provided on a centralised server which receives plant physiology, plant growth, plant health or other relevant agrotechnical or agricultural data from at least some plants fitted with the above mentioned pressure vessels. The plant data is monitored and processed. The central controller is provided with a computer readable medium which provides instructions to the controller to adjust the pressure in the aforementioned pressure vessels accordingly.

In some embodiments of the invention the controller and server may be on the same device.

In other embodiments of the invention the controller and the server are separate. In other embodiments of the invention the server may reside on site/farm or at a remote location.

Some embodiments of the present invention will provide the aforementioned method adapted to off-shore applications such as growing on a vessel, rig, raft, boat or other marine installation that moves on the ocean while pumping seawater.

The vessel, rig, raft, boat or other marine installation may move from one country to another or remain stationary and collect the abundant seawater.

The vessel, rig, raft, boat or other marine installation may cruise between one convenient location and head to the country market while growing the crops with the aforementioned method or system and harvest freshly upon arrival at the appropriate country market.

### EXAMPLE

A citrus plant, bitter orange, C.×aurantium was used in this experiment. The roots of these plants can develop a maximum osmotic pressure of 15 ATM under normal conditions.

Sea water of Osmotic pressure equivalent to 28 ATM ws used, mixed with sweet water 60%:40% to achieve an osmotic pressure of 16.8 ATM.

Method

Plants were placed in rows with 3 plants in each row. Each row was provided with the same water mixture (WM) of 16.8% osmotic pressure.

The control row was plants open to the air, under normal temperature and pressure. The experimental row was plants with their roots held under 4ATM pressure in pipes, and the WM was provided by a compressor pump.

Preparation

15-22 Oct. 2010, sweet water was provided atv 0.8 ATM.

22-29 Oct. 2010, 50% sea water was provided at 5 ATM.

22-29 Oct. 2010, 50% sea water was provided at 5 ATM.

29 October-5 November 50% sea water was provided at normal pressure.

From 5^{th} November 50% seawater was provide at 4.2 ATM.

Trial

The trial lasted from 5^{th} November to 19^{th} December at which time the plants were inspected.

Control group:
Plant no 1 was dead, with dry roots.
Plant no. 2 was infected with fungus and weeds and appeared to have been badly affected by them.
Plant no 3 had highly necrotic leaves.

Experimental group:
Plant no 1 was in poor condition.
Plant no 2 was in good condition.
Plant no 3 was in good condition.

The trial was continued until 12.02.2011 in the following manner: Surviving experimental plants were grown in pressure vessels under 4 ATM as previously described.

Table 2 show the results below:

| | A | B | C | D | E |
|---|---|---|---|---|---|
| 21 Jan. 2011 | Severe | Green | Green | Green | Green |
| | Necrosis | leaves | leaves | leaves | leaves |
| 28 Jan. 2011 | Did not | Green | Green | Green | Green |
| | survive | leaves | leaves | leaves | leaves |
| 05 Feb. 2011 | Did not | Green | Green | Green | Green |
| | survive | leaves | leaves | leaves | leaves |
| 12 Feb. 2011 | Did not | Green | Slight | Green | Severe |
| | survive | leaves | Necrosis | Leaves | Necrosis |

Conclusions

Growth of the above plants under higher than normal saline conditions is facilitated by placing the roots or rhizosphere under an osmotic pressure of approximately 4 ATM.

The pressurised cultivation system (PCS) can be adapted and modified to grow plants in higher salinity than normal.

1-54. (canceled)

55. A pressurised cultivation system (PCS) for growing plants in high salinity having
a. a vessel for growing at least one plant on a media, said vessel housing at least the roots of said at least one plant, and
b. a source of saline water;
wherein said vessel has a sealable upper portion in which the plant is rooted; said PCS further comprises a high pressure production unit operatively connected to said vessel for providing higher than ambient saline water pressure to said vessel, thereby maintaining said roots under high saline water pressure during growth thereof.

56. The PCS according to claim 55, wherein said pressure vessel has an opening hermetically sealable around a part of said plant such that the lower portion of said plant is in said vessel whilst the upper portion of said plant is in the ambient environment.

57. The PCS according to claim 55 provided with at least one component selected from the group consisting of a pressure release valve, a pressure sensor; a water salinity sensor; a water flow valve at the inflow to said vessel; a water flow valve at the outflow of said pressure vessel and any combination thereof.

58. The PCS according to claim 55, wherein said system is adapted for growing plants by any method from the group consisting of soiless culture, Aeroponics, Aquaponics, Aquascaping, Hydroponics, Passive hydroponics and any combination thereof.

59. The PCS according to claim 55, wherein said system is adapted for growing plants by any method selected from the group consisting of Aquatic gardening, •Bottle gardening, Bubbleponics, Deep water culture, Ebb and flow methods, Fogponics Microponics, Nutrient film techniques, Organic hydroponics, •Sub-irrigated planter methods and any combination thereof.

60. The PCS according to claim 55, wherein said pressure vessel is provided with at least one media or substrate selected from the group consisting of soil, growstones, charcoal, Coco peat, peat moss, Coco fibers Diatomaceous earth, Gravel, Perlite, Pumice, Rockwool, Sand •Vermiculite, Parboiled rice hulls, dolomites, basalt, expanded clay, aggregate, chalk, limestone, artificial polymer substrates, organic matter, mineral medium, organic medium and inert medium and any combination between them and any proportion thereof.

61. The PCS according to claim 55, wherein said system is provided with at least one accessory selected from the group consisting of Drip irrigation components Growlight, Hydroponic dosers, Irrigation sprinklers, Leaf sensors, Net-pots, Spray nozzles, Timers, Ultrasonic foggers and Water chillers.

62. The PCS according to claim 55, wherein said vessel is provided with an inflatable balloon at said hermetically sealable end; said inflatable balloon has an opening for enclosing said roots.

63. The PCS according to claim 55, wherein said vessel comprises an inflatable sleeve having openings at at least two hermetically sealable ends for enclosing around said roots such that at least a portion of said roots protrudes from beyond at least one said sleeve opening.

64. The PCS according to claim 55, wherein at least one of the following is true:
a. said vessel is adapted to be fitted to positively or negatively gravitropic aerial roots;
b. said vessel is adapted to be retrofitted to a crop, plant, shrub, bush, sapling or tree which is growing in a field;
c. said vessel is adapted to be fitted to a root of a scion or rootstock of a grafted plant;
d. said PCS is adapted to enable salt water to recirculated and fresh nutrients added as required or according to a specific protocol;
e. said salt water is provided under high pressure;
f. several vessels are networked in an integrated system controlled by a central controller;
g. more than one fields or greenhouses or growing establishments are networked in an integrated system controlled by a central controller;
h. said system further comprises a central controller and a central server adapted to receive plant physiology, plant growth, plant health or other relevant agrotechnical or agricultural data from at least some plants fitted with said pressure vessels;
i. said system is further provided with a processor for processing said plant physiology, plant growth, plant health or other relevant agrotechnical or agricultural data; and
j. said system is provided with a computer readable medium for providing instructions to the controller to adjust the pressure in said vessels in a predetermined manner.

65. The PCS according to claim 55, wherein said system is adapted for growing plants under high saline conditions wherein said plants are selected from the group consisting of almond, broadbean, barley, beet, apple, cabbage, brocolli, Bermuda grass, apricot, capsicum, Bromegrass, cotton, rubber plants, tobacco plants, avocado, clover, tallfescue, date, bean, cucumber, olive, sugarbeet, carrot, grape, ryegrass, citrus, eggplant, lettuce, safflower, onion, lucerne, sorghum, wheat, maize, peach, plum, peanut, strawberry, pepper, potato, spinach, sugarcane, and tomato.
